(19) United States
(12) Patent Application Publication
(10) Pub. No.: US 2026/0113816 A1
(43) Pub. Date: Apr. 23, 2026

(54) MAGNETIC DEVICE FOR INDUCTION HEATING THEREOF

(71) Applicant: XI'AN SUPERCONDUCTING MAGNET TECHNOLOGIES CO., LTD, Xi'an (CN)

(72) Inventors: Chao LI, Xi'an (CN); Meng LI, Xi'an (CN); Wei LIU, Xi'an (CN); Tong WEI, Xi'an (CN); Tao ZHANG, Xi'an (CN); Chuan CHEN, Xi'an (CN); Peng MA, Xi'an (CN); Zhengfu GE, Xi'an (CN); Xianhui LAN, Xi'an (CN); Tao ZHOU, Xi'an (CN)

(73) Assignee: XI'AN SUPERCONDUCTING MAGNET TECHNOLOGIES CO., LTD, Xi'an (CN)

(21) Appl. No.: 19/117,413

(22) PCT Filed: Nov. 15, 2024
(86) PCT No.: PCT/CN2024/132478

§ 371 Date: Oct. 15, 2025

(30) Foreign Application Priority Data
Nov. 20, 2023 (CN) 202311544388.7

(51) Int. Cl. H05B 6/44; H01F 41/04; H05B 6/06; H05B 6/36

(52) U.S. Cl. CPC H05B 6/44; H01F 41/048; H05B 6/067; H05B 6/367

(57) ABSTRACT

The present disclosure discloses a magnetic device for induction heating thereof that relates to the field of induction heating technologies. The magnetic device includes at least four coils that are even numbers, wherein the at least four coils are equally divided into two groups, and the two groups of coils are symmetrically arranged around an axis thereof; and a driving unit arranged on a symmetrical central axis of the coil and configured to drive a metal material to be heated to rotate. The present disclosure provides the even number of coils combined to form an annular coil device, so that a larger and more uniform magnetic field is generated in a center of the annular coil device, which can be more favorable for improving an eddy current heating effect thereof.

### BACKGROUND

### 1. CROSS-REFERENCE TO RELATED APPLICATION

This application is a national phase entry under 35 U.S. C § 371 of International Application No. PCT/CN2024/132478, filed on Nov. 15, 2024, which claims priority to Chinese Parent Application No. 202311544388.7, filed on Nov. 20, 2023, the entire contents of all of which are incorporated herein by reference.

### 2. TECHNICAL FIELD

The present disclosure generally relates to the field of induction heating technologies, and especially relates to a magnetic device for induction heating thereof.

### 3. DESCRIPTION OF RELATED ART

With the continuous improvement of industrialization, an amount of metal materials is increasing, and industrial production has put forward higher requirements for the supply of raw materials and semi-finished products. In this way, on the one hand, production enterprises must improve production efficiency and reduce production cycles, and on the other hand, they must promote energy-saving and emission reduction measures in industrial production to face the upcoming energy crisis.

In traditional metal smelting and processing fields, such as aluminum and zinc smelting and hot processing processes, it is necessary to melt or pre-heat aluminum and zinc for multiple times to obtain the maximum processing state. A conventional method is to use gas to heat a surface of the material for allowing naturally conduct to achieve an overall heating effect thereof. However, there are obvious disadvantages in conventional methods: the first is that the surface heating mode causes uneven heating of the material, for thicker materials, it can lead to large temperature differences between the inside and the outside of the material, which has a possibility of damaging crystal grain structures of the material, the second is that it requires a long time to wait for a temperature of the material to be uniformly distributed before subsequent processes can be performed, and the third is that an efficiency of the surface heating mode is low, about 30% to 50%, thereby resulting in significant energy wastes.

In view of defects of the surface heating mode, induction heating methods are currently present. When using the induction heating mode, a magnet generates a magnetic field, and a metal material moves in the magnetic field, in this way, a relative movement between the magnetic field and the metal material will generate eddy currents inside the metal material, so that an existence of the eddy currents will heat the metal material, with a heating efficiency of 70-90%, which greatly reduces product energy costs of products and increasing product competitiveness thereof. However, when using the induction heating mode, magnetic conductive materials are used to guide the magnetic field to form a certain uniform magnetic field in a heating area thereof. A problem of this method is that a uniform magnetic field strength formed by the magnetic conductive material is low, thereby requiring longer heating times and higher rotation speed requirements.

### SUMMARY

The technical problems to be solved: in view of the shortcomings of the related art, the present disclosure provides a magnetic device for induction heating thereof which can solve problems of a low magnetic field intensity caused by using magnetic conductive materials in the related art.

In an aspect, a magnetic device for induction heating thereof according to an embodiment of the present disclosure, includes:
at least four coils that are even numbers, wherein the at least four coils are equally divided into two groups, and the two groups of coils are symmetrically arranged around an axis thereof; and
a driving unit arranged on a symmetrical central axis of the coil and configured to drive a metal material to be heated to rotate.

Wherein the magnetic device further includes a housing that is an annular cylinder structure, an inner wall of the housing internally surrounded to form a heating area thereof, a magnetic field area surrounded between an outer wall and the inner wall of the housing, the heating area configured to place the metal material, and the at least four coils set in the magnetic field area.

Wherein a magnetic shielding material is arranged on the outer wall.

Wherein the at least four coils are positioned in the magnetic field area by a coil bracket.

Wherein the at least four coils are made of superconducting materials.

Wherein each of the at least four coils is an annular structure or a rectangular annular structure.

Wherein each of the at least four coils is solidified by a curing agent after being winded.

The magnetic device for induction heating thereof of the present disclosure has the following advantages:
firstly, the even number of coils are combined to form an annular coil device, so that it can generate a larger and more uniform magnetic field in a center thereof, which can be more favorable for improving an eddy current heating effect thereof;
secondly, circular coils are more suitable for a layout of production sites, and materials can be fed vertically or horizontally, which is more conducive to layouts of automated production lines thereof; and
thirdly, a weight of a product can be greatly reduced without needing a magnetic conductive material thereof.

### BRIEF DESCRIPTION OF THE DRAWINGS

In order to more clearly understand the technical solution hereinafter in embodiments of the present disclosure, a brief description to the drawings used in detailed description of embodiments hereinafter is provided thereof. Obviously, the drawings described below are some embodiments of the present disclosure, for one of ordinary skill in the related art, other drawings can be obtained according to the drawings below on the premise of no creative work.

FIG. 1 is a schematic view of an overall structure of a magnetic device for induction heating thereof in accordance with an embodiment of the present disclosure.

FIG. 2 is a schematic view of a magnetic field of the magnetic device for induction heating thereof of the present disclosure.

The element labels according to the embodiment of the present disclosure shown as below:
100 housing, 200 coil, 300 metal material.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. Obviously, the implementation embodiment in the description is a part of the present disclosure implementation examples, rather than the implementation of all embodiments, examples. According to the described exemplary embodiment of the present disclosure, all other embodiments obtained by one of ordinary skill in the related art on the premise of no creative work are within the protection scope of the present disclosure.

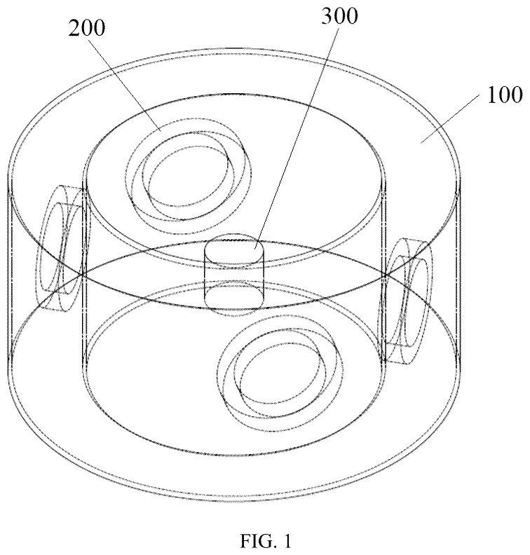

FIG. 1 is a schematic view of a magnetic device for induction heating thereof in accordance with an embodiment of the present disclosure. The magnetic device of the present disclosure includes:
at least four coils 200 that are even numbers, wherein the at least four coils 200 are equally divided into two groups, and the two groups of coils 200 are symmetrically arranged around an axis thereof; and
a driving unit arranged on a symmetrical central axis of the coil 200 and configured to drive a metal material 300 to be heated to rotate.

Specifically, the number of the at least four coils 200 is preferably four, and when the four coils 200 are used, the number of coils 200 in each group is two. When using the four coils 200, a higher magnetic field can be generated relative to two coils 200, and the four coils 200 are centrally symmetrically arranged. an included angle between axes of the two coils 200 in the same group is 60°or 80°. Such angle setting mode can form an approximately uniform magnetic field with and consistent direction near the symmetrical central axis thereof, so that the metal material 300 can cut magnetic induction lines in the magnetic field when rotating in this area within the magnetic field, thereby forming eddy currents inside the metal material 300.

When six or more coils 200 are used, it can provide a stronger magnetic field, and the uniformity and direction consistency of the magnetic field are also good. In actual application scenarios, the number and arrangement angles of the coil 200 can be flexibly selected according to needs.

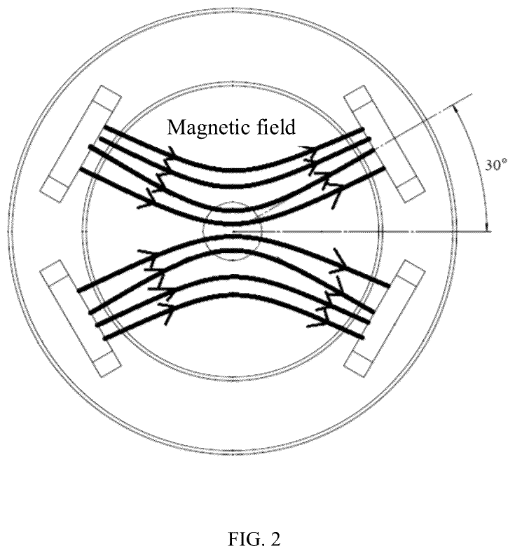

After the coils 200 are set, a symmetrical central axis in a vertical or horizontal direction will be formed, and centers of a plurality of coils 200 will be in the same plane perpendicular to the symmetrical central axis, so that the magnetic fields generated after the plurality of coils 200 are energized and excited are also in mutually overlapping areas, which is as shown in FIG. 2. It should be understood that shapes and sizes of the plurality of coils 200 will affect the magnetic field, and in order to ensure that the magnetic fields generated by the plurality of coils 200 are in the same plane, it is necessary to ensure that each of the plurality of coils 200 is identical in the shape and the size thereof, in addition to ensuring that installation positions of the plurality of coils 200 are uniform.

In an embodiment of the present disclosure, the coil 200 is made of a superconducting material. Specifically, wires made of high-temperature superconducting materials or low-temperature superconducting materials can be wound to form an annular or rectangular annular coil 200, and after winding the wires is completed, the coil 200 can be solidified by a curing agent, so as to improve a strength of the coil 200 and prevent deformation during usage of the coil 200.

A motor can be used as the driving unit, which can be directly driven or drive the metal material 300 to rotate through gears, belts and other driving mechanisms. A rotation axis of during rotation coincides with the symmetrical central axis of the coil 200. When the metal material 300 is installed on the driving unit, positions to be heated are located in the uniform magnetic field area with consistent direction that is formed by the coil 200, at this time, the driving unit drives the metal material 300 to rotate, which can generate eddy currents inside the metal material 300 and heat the position of the metal material 300 that is to be heated.

In a possible embodiment of the present disclosure, the magnetic device further includes a housing 100 that is an annular cylinder structure. An inner wall of the housing 100 internally surrounded to form a heating area thereof, a magnetic field area surrounded between an outer wall and the inner wall of the housing 100, the heating area configured to place the metal material 300, and the at least four coils 200 set in the magnetic field area.

Specifically, the housing 100 can adopt a cylindrical or prismatic ring-shaped cylinder, with a closed magnetic field area inside thereof. When the coil 200 is set in the housing 100 through a coil bracket, the coil 200 can be cooled to a critical temperature or below the critical temperature by liquid helium or other cooling methods, to maintain a low temperature environment, so that the coil 200 is always in a superconducting state. After being powered on, the coil 200 can withstand hundreds of amperes of current and generate a strong magnetic field, thereby improving the magnetic field intensity in the heating area and reducing speed requirements of the driving unit during the heating process.

Furthermore, a magnetic shielding material is arranged on the outer wall of the magnetic field area, which can be made of ferromagnetic metals such as iron, nickel and alloy thereof. By setting the magnetic shielding material, the magnetic field generated by the coil 200 can be limited to the magnetic field area and the heating area, rather than propagating to the outside of the magnetic field area, thereby avoiding any influences on external devices and personnel.

Although the preferred embodiments of the present disclosure have been described, one of ordinary skill in the art can make additional variations and modifications to these embodiments once basic inventive concepts are known. Therefore, the attached claims are intended to be interpreted as including preferred embodiments and all variations and modifications falling within the scope of the present disclosure.

Obviously, any variation or replacement produced by one of ordinary skill in the art without departing from the spirit and scope of the present disclosure. In this way, if these modifications and variations of the present disclosure fall within the scope of the claims and equivalent technologies of the present disclosure, then the present disclosure is also intended to encompass these modifications and variations.

1. A magnetic device for induction heating thereof comprising:
at least four coils (200) that are even numbers, wherein the at least four coils (200) are equally divided into two groups, and the two groups of coils (200) are symmetrically arranged around an axis thereof; and
a driving unit arranged on a symmetrical central axis of the coil (200) and configured to drive a metal material (300) to be heated to rotate, to heat the entire metal material (300) to be heated under an action of the magnetic field.

2. The magnetic device as claimed in claim 1, wherein the magnetic device further comprises a housing (100) that is an annular cylinder structure, an inner wall of the housing (100) internally surrounded to form a heating area thereof, a magnetic field area surrounded between an outer wall and the inner wall of the housing (100), the heating area configured to place the metal material (300), and the at least four coils (200) set in the magnetic field area.

3. The magnetic device as claimed in claim 2, wherein a magnetic shielding material is arranged on the outer wall.

4. The magnetic device as claimed in claim 2, wherein the at least four coils (200) are positioned in the magnetic field area by a coil bracket.

5. The magnetic device as claimed in claim 1, wherein the at least four coils (200) are made of superconducting materials.

6. The magnetic device as claimed in claim 1, wherein each of the at least four coils (200) is an annular structure or a rectangular annular structure.

7. The magnetic device as claimed in claim 1, wherein each of the at least four coils (200) is solidified by a curing agent after being winded.
